(19) United States
(12) Patent Application Publication
(10) Pub. No.: US 2015/0354953 A1
(43) Pub. Date: Dec. 10, 2015

(54) LASER TRIANGULATION SENSOR AND METHOD OF MEASUREMENT WITH LASER TRIANGULATION SENSOR

(71) Applicant: nokra Optische Prüftechnik und Automation GmbH, Baesweiler (DE)

(72) Inventors: Christian HELLMANN, Wurselen (DE); Michael KRAUHAUSEN, Aachen (DE)

(21) Appl. No.: 14/735,353

(22) Filed: Jun. 10, 2015

(30) Foreign Application Priority Data
Jun. 10, 2014 (DE) 102014108136.6

(51) Int. Cl. G01C 3/10; G01B 9/02

(52) U.S. Cl. CPC G01C 3/10; G01B 9/02029

(57) ABSTRACT

An apparatus for measuring the distance to a workpiece, in particular a laser triangulation device is described. The apparatus includes a source of coherent radiation for illuminating the workpiece along an optical axis at a first angle relative to the surface of the workpiece, and an optical arrangement for detecting scattered light generated by the illumination, wherein the optical arrangement detects the scattered light at a second angle relative to the surface of the workpiece and wherein the second angle is different from the first angle. The optical arrangement includes detector that is spatially resolving it at least one dimension for the spatial resolved detection of the scattered light, and an interferometer comprising at least one moveably arranged mirror, which is disposed in the optical arrangement in such a way as to be in the path of at least a portion of the scattered light.

Embodiments of the invention relate to a method and a device for the geometric measurement or inspection of a surface of a workpiece, in particular for detecting at least a distance of a workpiece from a measurement device.

### TECHNICAL BACKGROUND

In laser triangulation, a laser beam (for low requirements, the radiation of a light-emitting diode) is focused onto the measuring object and observed with a photosensitive spatially resolved detector (e.g. CCD-line). If the distance of the object from the sensor changes so will the angle under which the light spot is observed. Due to the changed angle, the imaging on the detector results in a changed position of the image on the detector. The distance of the object is calculated from the change in position.

The detector refers to a photosensitive element that can make a spatially resolved measurement, wherein a spatial resolution in at least one dimension is provided. The spatial resolution is used to determine the position of the light spot in the image. The distance between the sensor and the object is calculated from this image position.

One advantage of laser triangulation is that the image position relates to essentially trigonometric relationships. The measurement can be performed continuously or quasi-continuously and thus is well suited for distance measurement on moving objects. To reduce ambient light sensitivity and the influence of inhomogeneous reflective surfaces, the measuring point is generally chosen to be as small and bright as possible. Therefore, lasers are primarily used as a light source.

The problem of laser triangulation with coherent light is the limitation of the measurement accuracy due to speckle effects. Speckles randomly affect the intensity distribution or the intensity focus of an image of coherent laser radiation. Therefore, determination of the focus of intensity and thus the measured distance value (or the spatial resolution) is subject to interference by the speckles.

An unwanted speckle granulation in intensity distributions may be reduced or eliminated through the use of a moving diffuser. Thereby, the occurrence of speckles is continuously varied during the integration time of a detector.

### DISCLOSURE OF THE INVENTION

The above stated problems of the prior art are at least partially solved by a device according to claim 1 and a method according to claim 10. Preferred embodiments and special aspects arise from the dependent claims, the drawings and the description.

According to one embodiment, a device for measuring the distance to a workpiece, in particular, a laser triangulation device is provided. The device includes a source of coherent radiation for illuminating the workpiece along an optical axis at a first angle relative to the surface of the workpiece, and an optical arrangement for detecting scattered light generated by the illumination, wherein the optical arrangement detects the scattered light at a second angle relative to the surface of the workpiece, and wherein the second angle is different from the first angle. The optical arrangement includes a detector, spatially resolving in at least one dimension for the spatial resolved detection of the scattered light, and an interferometer comprising at least one movably arranged mirror, which is provided in the optical arrangement to be in the path of at least a portion of the scattered light. A phase shift of the portions of the scattered light relative to each other may be generated by the optical path of the scattered light over a movable mirror. Thereby, the production of speckles can be reduced or eliminated, which was not possible by using conventional methods of laser triangulation in particular at the occurring high measured frequencies, for example, of several 10 kHz.

According to a further modified embodiment, the interferometer further includes a second, fixed mirror and a beam splitter, wherein the second stationary mirror is arranged to be in the beam path of at least a second portion of the scattered light. Typically, in this case, the beam splitter can produce the first portion of the scattered light and the second portion of the scattered light. Due to the superposition of a scattered light signal, which is reflected on a fixed mirror, and a scattered light signal, which is reflected on a movable mirror, a phase difference can be generated between the respective portions of the scattered light signal.

According to further embodiments, the device may further include an actuator, in particular a piezo-actuator, wherein the movably arranged mirror is moved by the actuator. For example, the actuator may move the movably arranged mirror with an oscillatory movement. The oscillatory movement or the movement with a piezo-actuator, for example, a piezoceramic or a piezo crystal permits a rapid movement and an easily achievable implementation of the generation of a phase difference.

According to other typical embodiments, the actuator can move the movably arranged mirror substantially perpendicular to the mirror surface. This can be done by a movement of the mirror perpendicular to the mirror surface, or also by a tilting of the mirror, i.e. a raising and/or lowering at least one edge of the mirror in a direction perpendicular to the mirror surface.

According to a further embodiment of the invention, the device further includes a controller, which is adapted to read-out the detector with a predetermined frame rate, or to start a read-out at a predetermined frame rate, wherein the controller is further adapted to control the movement of the actuator with a movement frequency that is at least 0.5 times the frame rate, in particular, at least 2 times the frame rate, or to start the movement with the movement frequency. Specifically, the controller can synchronize the read-out and the movement or the controller can synchronize the start of the read-out and the start of the movement. By way of example, the frame rate may be 20 kHz or more, more preferably 30 kHz or more, like for instance 40 kHz to 80 kHz. The more rapid movement of the mirror, in particular synchronized movement, allows for a reliable reduction of the speckle.

In a further preferred embodiment, the movably arranged mirror may be movable by a distance of at least λ/4, in particular by a distance with a value in the range of λ/2 to λ. For example, the mirror can be movable by a distance of at least 200 nm, in particular by a distance with a value in the range of 300 nm to 500 nm. This allows for a convenient phase shift to reduce the speckle.

According to a further embodiment, a method of operating a laser triangulation sensor for distance measurement to a workpiece is provided, wherein the sensor having an optical arrangement for detecting scattered light generated by an illumination may be provided with a detector spatially resolving in at least one dimension for the spatial resolved detection of the scattered light and an interferometer with at least one movably arranged mirror. The method includes illuminating the workpiece along an optical axis at a first angle relative to the surface of the workpiece, wherein the scattered light-providing illumination system and the movement of the movably arranged mirror is provided, wherein the movement is, in particular, an oscillation.

According to a modification provided herein, the method may further include reading out the detector with a predetermined frame rate, wherein the movement of the actuator of the movably arranged mirror is carried out with a movement frequency that is at least 0.5 times the frame rate, in particular at least 2 times the frame rate. In particular, the read-out and the movement can be synchronized. According to typical embodiments, which can be combined with the embodiments described herein, the movably arranged mirror is movable by at least a distance of λ/4, in particular by a distance with a value in the range of λ/2 to λ. For example, the mirror can be movable by a distance of at least 200 nm, in particular by a distance with a value in the range of 300 nm to 500 nm. Further, the movement may occur with a frequency of 50 kHz and more, particularly, with a frequency of 150 kHz or more.

### BRIEF DESCRIPTION OF THE FIGURES

Embodiments of the invention are illustrated in the figures and are described in more detail below. Shown are:

FIGS. 1A and 1B show a principle of a laser triangulation sensor as can be used for the devices and methods of the embodiments described herein;

FIG. 2 shows a device for measuring the distance to a workpiece, in particular a laser triangulation device with a movable mirror according to embodiments described herein;

FIG. 3 shows a further device for measuring the distance to a workpiece, in particular a laser triangulation device with a movable mirror and a controller according to embodiments;

FIG. 4 shows a yet further device for measuring the distance to a workpiece, in particular a laser triangulation device with a movable mirror according to embodiments described herein, wherein a tilting of the mirror is shown; and

FIG. 5 shows a yet further device for measuring the distance to a workpiece, in particular a laser triangulation device with a movable mirror according to embodiments described herein, wherein a two-dimensional spatial resolving detector is used.

### DETAILED DESCRIPTION OF THE EMBODIMENTS

In order to describe in detail, with reference to the embodiments of which some are illustrated in the accompanying figures, to what the above-mentioned features of the embodiments of the invention relate, below is a detailed description of the above-mentioned briefly summarized embodiments of the invention. However, it is noted that the appended figures illustrate only typical embodiments of this invention and are therefore not to be considered limiting of its scope since the invention may also admit to other equally effective embodiments. Same reference numerals are generally being used for the same or similar elements.

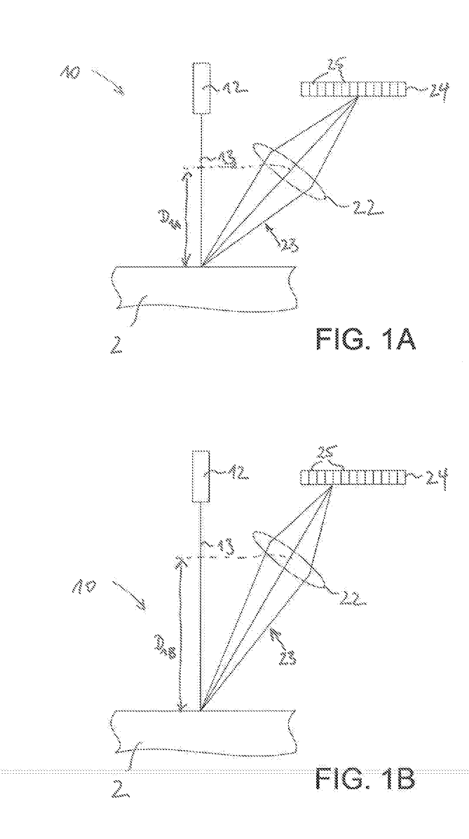

FIGS. 1 A and 1B show a schematic representation of a device 10 for measuring the distance to a workpiece 2. Typically, the device is a triangulation sensor. FIGS. 1A and 1B illustrate the influence of a distance from the workpiece 2. Thereby, in FIG. 1A a distance D1A and in FIG. 1B a distance D1B are drawn. A source 12 of coherent radiation, typically a laser, of the triangulation sensor emits a beam 13 onto the surface of the workpiece 2. This is done at a first angle. As shown in FIGS. 1A and 1B, this angle can typically be substantially 90°. An optical arrangement detects the scattered light caused by the laser beam 13. The scattered light is indicated in FIGS. 1A and 1B by reference numeral 23. The scattered light is detected at a second angle, wherein the second angle is different from the first angle of the laser radiation 13. According to typical embodiments, the second angle or the region of the second angle is defined by the central beam of the scattered light, that is, the beam that passes through the center of the lens 22 and the laser beam direction.

As can be seen from a comparison of FIGS. 1A and 1B, a variation of the distance from D1A to D1B or any other value lying in the measuring range results in a change of the angle of the detected scattered light. Typically, the second angle is in a range from 15° to 40°.

A triangulation sensor conventionally comprises a radiation source such as a laser and at least one line detector (or a 2-D resolution detector as illustrated in FIG. 5) on which a spot, illuminated by the laser through a lens, is imaged. Information on the distance to the point can be derived from the place on the line detector on which the point is imaged. The intensity of the light reflected to the triangulation sensor has no effect on the measured distance.

The lens 22 transmits the scattered light onto the detector 24. Thereby, the detector is spatial resolving in at least one dimension. For example, the detector may be a CCD-line with elements 25 so that in dependence with the exposure of the elements 25, for example, individual pixels of a CCD-line, a spatial resolved measurement of the scattered light can be made. Varying the distance and the associated change of the detection angle, results in a varying position of the intensity focus. The distance in each position of the intensity focus in the unit of pixels may be assigned to a unit of length.

According to further embodiments, which can be combined with the embodiments described herein, a narrow-band bandpass filter (not shown) may be provided in the beam path of the scattered light, which is typically tuned to the wavelength of the laser. Thus, a detector such as a CCD array may be made insensitive for the most part to the exposure of light of different wavelengths.

According to further typical embodiments, in order to focus the laser beam 13 starting from the source 12 onto the surface of the workpiece 2, a lens (not shown) may also be provided in the beam path of the illumination of the workpiece 2. A respective lens may optionally be integrated in the source 12 or the laser.

During laser triangulation that is generally during a triangulation with a source of coherent radiation, the measurement accuracy may be limited by speckle effects. Speckles influence the intensity distribution of the image of the measurement point on the detector 24. In other words, the intensity focus of the scattered light imaged on the detector is randomly influenced. This random influence of the intensity focus leads to a random fluctuation in the determined distance value or a reduction in the spatial resolution. Thus, the measured distance value or the resolution is subject to an uncertainty.

For several reasons, the use of moving diffusers for triangulation sensors cannot be used or can only be used with an insufficient result. Moving diffusers may reduce or eliminate the presence of a speckle pattern. With moving diffusers, the expression of the speckles can be continuously varied during the integration time of a detector. Thereby, however, the now a days desired very high measuring frequencies for laser triangulation sensors can hardly be realized or not be realized at all. Furthermore, a diffuser in the beam path affects the imaging either in the illumination beam path or in the detection beam path.

According to embodiments of the description, by coherent overlap of a speckle pattern with a reference wave, the expression of subjective speckle patterns depend on the phase difference of the speckle pattern to the reference wave may be influenced. If the phase difference, for example, varies by it (pi), the result is a non-correlating new speckle pattern. By continuously changing the phase difference during the exposure time of a detector, the speckle effect can be averaged out. Thus, the influence of speckle, which overlaps the actual image on the detector, i.e. a peak image of the measuring point generated by the laser beam on the surface of the workpiece, can be reduced or eliminated.

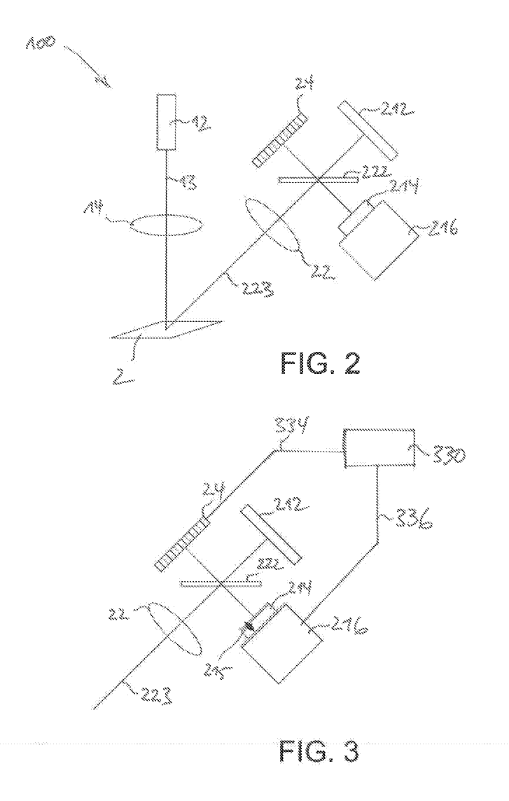

FIG. 2 shows a device 100 for measuring the distance to a workpiece 2, in particular a laser triangulation sensor. A source 12 of coherent radiation, for example, a laser that emits a laser beam 13, which in FIG. 2 is focused by, for instance, a lens 14 on the workpiece 2 or the surface thereof. Analogous to the FIGS. 1A and 1B scattered light 223 is detected at an angle, which differs from the angle of the irradiating laser light. The lens 22 maps the measuring point on the surface of the workpiece 2 on the detector 24.

In typical embodiments, the detector 24 is spatially resolving in at least one dimension. The detector may be selected from the group consisting of: a CCD line, a spatially resolving photodiode, an array of photodiodes, a CCD array, a CMOS sensor, or specific types of CCD sensors.

The embodiment illustrated in FIG. 2 includes a beam splitter 222, so that a portion of the scattered light 223 is directed onto a fixed mirror 212. The fixed mirror 212 reflects this portion of the scattered light. The portion of scattered light reflected at the mirror 212 is directed via the beam splitter 222 on to the detector 24. Further, the beam splitter 222 directs another portion of the scattered light on the movably arranged mirror 214. The scattered light reflected at the movably arranged mirror 214 is directed through the beam splitter to the detector 24. According to typical embodiments, the movably arranged mirror 214 is arranged to an actuator, which moves the mirror 214. Thereby, typically the mirror 214 moves back and forth, i.e. an oscillatory motion is generated by the actuator 216.

According to typical embodiments, the actuator may be a piezoceramic or piezo crystal. Furthermore, the movably arranged mirror 114 typically moves in a direction substantially perpendicular to the surface of the mirror. As a result, the optical path length for the portion of the scattered light 223, which is reflected at the movably arranged mirror 114, is changed, particularly when compared to the other portion of the scattered light which is reflected at the fixed mirror 212. By changing the optical path length, a phase difference is generated between portions of the scattered light. By generating a suitable phase difference, as described inter alia in relation to FIG. 3, the influence of speckles can be reduced or eliminated. According to further embodiments a phase difference can also be carried out by the movement of two mirrors, wherein in this case typically a synchronization of the two movements of the two mirrors is provided. Furthermore, the two mirrors shown in the embodiment of FIG. 2 can interchange their roles so that the mirror 212 is attached to an actuator, and is thus movable while the mirror 214 is fixedly mounted.

FIG. 3 shows a detail of the optical arrangement for detecting the scattered light 223. Further to FIG. 2, the movement of the movably arranged mirror 214 is shown by the double arrow 215. In addition, FIG. 3 shows a controller 330, which is connected via signal lines with the detector 24 and the actuator 216.

The controller 330 may place in relation to one another, in particular synchronize, the measurement frequencies or the frame rate at which the detector 24 is read-out and the frequency with which the actuator 216 moves the mirror 214.

According to typical embodiments, the frame rate of a device for a distance measurement is 10 kHz or more, in particular 30 kHz or more, further in particular 40 kHz or more, e.g. 40 kHz to 80 kHz. The actuator is typically moved at a frequency of at least half the frame rate, or at least twice the frame rate. Hereby, in particular a movement is initiated, which produces a phase shift of π. For example, the mirror is moved in order to produce a change of the optical path length by about 200 nm or more, particularly to produce a path with a value in the range of 300 nm to 500 nm.

According to typical embodiments, the reading out of the detector 24 and the movement of the mirror 214 can be synchronized by means of the actuator 216. Hereby, single read-out operations can be synchronized with movements or a sequence of read-outs can be synchronized with the movements. Typically, during the synchronization the read-out operation of the detector 24 can be assigned a higher priority such that the movement is adapted to the reading out process in the case that the synchronization is corrected.

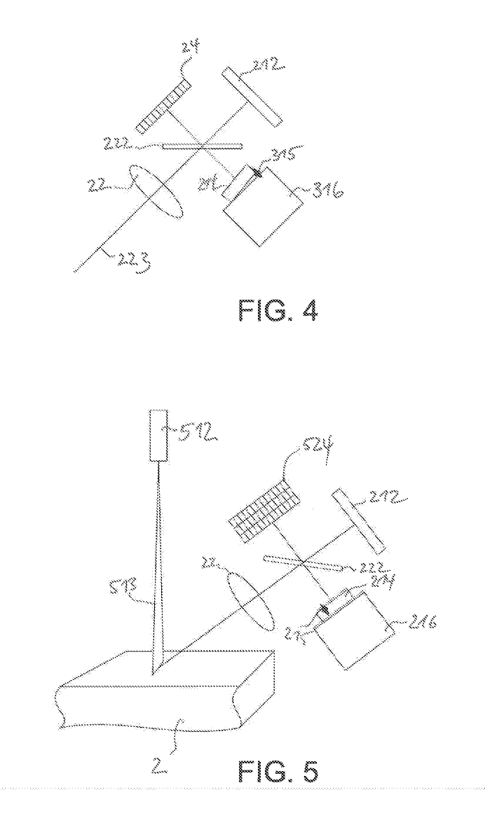

FIG. 4 branches off a further embodiment, which may be combined with the embodiments described herein. In contrast to FIG. 3, in FIG. 4 the mirror 214 is tilted. That is, by way of example a movement only takes place at one end of the mirror or a position of the mirror remains essentially stationary. According to other embodiments, the movement of the mirror can also be described by a rotation, which causes a tilt of the wave fronts of the partial beams and hence also causes a phase difference.

According to typical embodiments, the tilting or rotation can take place about an axis, which is parallel to the direction of the spatial resolution of the detector. Hereby, for example, when using a CCD line, the tilting movement may cause a movement of the imaging element within an element or pixel along the pixel height. Thereby, the pixel height is perpendicular to the direction of the spatial resolution. A movement of the imaging element in the direction of the pixel width, i.e. towards the adjacent element of the detector can lead to a modulation or smearing of the measuring signal. Clearly, with respect to FIG. 5 below, such a movement can also be effected about an axis, which is, for example, perpendicular to a direction of the spatial resolution. According to further options, a combination of translation and rotation may also be used to generate the phase shift.

FIG. 5 shows a further embodiment in accordance with embodiments described herein. As a further modification, which can be combined with the embodiments described herein, a linear emitting beam source 513, for example, in the form of a line laser may be used instead of a substantially round beam of coherent light where one measurement point is generated on the workpiece 2. A line is provided that is focused on the measurement range of the sensor so that a further dimension can be added, i.e., the distance of the workpiece to the sensor is not only determined in one place, but along the line. The spatial resolution along the line is provided on the side of a detector by the detector 524, wherein, for example, a CCD array or a different array is used.

While the foregoing is directed to embodiments of the invention, without departing from the basic scope other and further embodiments of the invention may be conceived, and the scope thereof is determined by the following claims.

1. A device for measuring the distance to a workpiece, in particular for laser triangulation, the device comprising:
a source of coherent radiation for illuminating the workpiece along an optical axis at a first angle relative to the surface of the workpiece;
an optical arrangement for detecting scattered light produced by the illumination, wherein the optical arrangement detects the scattered light at a second angle relative to the surface of the workpiece and wherein the second angle differs from the first angle;
wherein the optical arrangement comprises:
a detector that is spatially resolving in at least one dimension for a spatial resolved detection of the scattered light; and
an interferometer comprising at least one movably arranged mirror, which is disposed in the optical arrangement in such a way as to be in the path of at least a portion of the scattered light.

2. The device according to claim 1, wherein the interferometer further comprises:
a second fixed mirror and a beam splitter, wherein the second fixed mirror is arranged to be in the beam path of at least a second portion of the scattered light.

3. The device according to claim 2, wherein the beam splitter generates the first portion of the scattered light and the second portion of the scattered light.

4. The device according to claim 1, further comprising:
an actuator, in particular a piezo-actuator, wherein the movably arranged mirror is moved by the actuator.

5. The device according to claim 4, wherein the actuator is a piezo-actuator.

6. The device according to claim 4, wherein the actuator moves the movably arranged mirror with an oscillatory movement.

7. The device according to claim 4, wherein the actuator moves the movably arranged mirror substantially perpendicular to the mirror surface.

8. The device according to claim 4, further comprising:
a controller, which is adapted to read-out the detector at a predetermined frame rate or to start a reading out at a predetermined frame rate, wherein the controller is further adapted to control the movement of the actuator with a movement frequency that is at least half the frame rate or to initiate the movement with the movement frequency.

9. The device according to claim 8, wherein the movement frequency is at least equal to the frame rate.

10. The device according to claim 8, wherein the controller synchronizes the reading out and the movement or synchronizes the start of the reading out and the start of the movement.

11. The device according to claim 1, wherein the movably arranged mirror is movable by at least a distance of 200 nm, in particular by a distance with a value in the range of 300 nm to 500 nm.

12. The device according to claim 11, wherein the movably arranged mirror is movable by a distance with a value in the range of 300 nm to 500 nm.

13. A method of operating a laser triangulation sensor for distance measurement to a workpiece having an optical arrangement for detecting scattered light generated by illumination with a detector spatially resolving in at least one dimension for the spatial resolved detection of the scattered light, and an interferometer with at least one movably arranged mirror;
illuminate the workpiece along an optical axis at a first angle relative to the surface of a workpiece, wherein the scattered light generating illumination is provided;
moving the movably arranged mirror, wherein the movement is in particular a oscillation.

14. The method according to claim 13, further comprising:
reading out the detector with a predetermined frame rate, wherein the movement of the actuator of the movably arranged mirror is executed with a movement frequency of at least 2 times the frame rate.

15. The method according to claim 14, wherein the movement frequency is at least 3 times the frame rate.

16. The method according to claim 14, wherein the reading out and the movement are synchronized.

17. The method according to claim 13, wherein the movably arranged mirror is moved at least by a distance of 200 nm, in particular by a distance with a value in the range of 300 nm to 500 nm.

18. The method according to claim 13, wherein the movably arranged mirror is moved by a distance with a value in the range of 300 nm to 500 nm.

19. The method according to claim 13, wherein the movement is carried out with a frequency of 50 kHz and more.

20. The method according to claim 13, wherein the movement is carried out with a frequency of 150 kHz or more.
